(19) United States
(12) Patent Application Publication
(10) Pub. No.: US 2013/0148195 A1
(43) Pub. Date: Jun. 13, 2013

(54) COMPACT, LIGHT-TRANSFER SYSTEM FOR USE IN IMAGE RELAY DEVICES, HYPERSPECTRAL IMAGERS AND SPECTOGRAPHS

(71) Applicant: Stephen Achal, Calgary (CA)

(72) Inventor: Stephen Achal, Calgary (CA)

(73) Assignee: ITRES RESEARCH LIMITED, Calgary, AB (CA)

(21) Appl. No.: 13/698,147

(22) PCT Filed: May 12, 2011
(86) PCT No.: PCT/CA2011/000558

§ 371 Date: Jan. 28, 2013

Related U.S. Application Data
(60) Provisional application No. 61/345,668, filed on May 18, 2010.

(51) Int. Cl. G02B 17/08

(52) U.S. Cl. CPC G02B 17/08; G02B 17/0892
USPC 359/351; 359/727; 359/728

(57) ABSTRACT

The invention provides a light-transfer imager that can be incorporated into a hyperspectral line-scanner, a spectrograph or a non-diffractive image relay device, and more particularly, to a design having a simpler optical design that is easier to fabricate, and has superior imaging quality than most previous designs. The invention includes a generic first optical assembly to deliver incoming light onto a slit or pinhole, a second optical assembly operating as a refractive corrector that directs incoming light onto a curved reflective diffraction grating or curved mirror such that the spectrally dispersed or reflected light (dependent upon the particular embodiment) passes back through the same second optical assembly which focuses that light onto a focal plane array (FPA) in approximately the same plane as the slit. The slit and the FPA are preferably displaced symmetrically on opposite sides of the optical axis of the refractive corrector.

### FIELD OF THE INVENTION

This invention relates generally to the optical design of light-transfer imagers as used in image relay devices, hyperspectral imagers and spectrographs and more particularly, to a design having a simpler optical design that is easier to fabricate, and has superior spectral and spatial imaging quality than most previous designs.

### BACKGROUND OF THE INVENTION

Current light-transfer imagers based on an “Offner” design tend to be relatively large and suffer from difficulty in achieving and maintaining alignment of the multiple optical axes.

Current light-transfer imager designs based on a “Dyson” design are compact, but are severely constrained in the back focal length such that the focal plane array (FPA) must be placed very close to the Dyson optical block as exemplified in U.S. Pat. No. 7,609,381 (Warren). As a result, there has been a need for optical imaging systems having greater physical separation of the FPA from the closest optical element thereby permitting enhanced flexibility in the mechanical design associated with the FPA.

Furthermore, for FPAs with a large number of pixels, which is typically desirable for high quality mapping and image relay applications, a further limitation of the Dyson design is that the Dyson block becomes physically large so that achieving and maintaining thermal equilibrium within the block requires significant time before operations and can lead to degradation of the resultant image if incompletely achieved or maintained.

Another major limitation on image quality from a Dyson design is the fact that light travels in both directions (before and after diffraction for spectrographic designs) through the same large block in such a way that incoming light can be scattered within and at the edges of the Dyson block back on the FPA. Moreover, the Dyson design as exemplified in U.S. Pat. No. 7,609,381 (Warren) is such that it is not possible to include optical baffling to prevent this scattering. Such scattering can be a significant problem for spectrographic applications since the incoming light that is scattered is full spectrum whereas the desired signal reaching the FPA is spectrally dispersed falling onto different parts of the FPA, each having only a tiny fraction of the full-spectrum spectral energy. Scattered light can then become a significant fraction of the total energy impinging onto the FPA for some wavelengths.

Further still, other optical designs, as exemplified by U.S. Pat. No. 7,199,876 (Mitchell) and U.S. Pat. No. 7,061,611 (Mitchell) incorporate an optical assembly between the slit and the dispersing grating, in order to collimate the light passing through the slit so that a planar mirror, a planar reflective diffraction grating or a planar transmission grating can be used. This need to collimate the light adds a much higher level of optical complexity with the attendant increase in scattered light.

Accordingly, there has been a need for a simpler optical assembly between the slit and the dispersive grating such that scattered light is reduced and there is no need to collimate light.

### SUMMARY OF THE INVENTION

In accordance with the invention, a compact, light-transfer transfer system is described.

It is an objective of the invention to provide a light transfer system design that is physically compact.

It is an objective of the invention to provide an optical design that can be used effectively for FPA's with a large number of pixels, including large format pixels, and with minimal keystone and spectral smile distortions (for diffractive embodiments), suitable for high quality imaging applications.

It is a further objective that the optical design contains a minimal number of optical elements that are readily manufacturable.

It is a further objective that the optical design achieves and maintains minimal spectral smile (for diffractive embodiments) and keystone distortions without complex alignment procedures.

It is a further objective that the optical design achieves excellent image quality including being largely diffraction-limited for all wavelengths of interest across the full FPA when used in a hyperspectral imaging design.

It is a further objective that the optical design format is sufficiently general that it can be used over different spectral ranges from the ultraviolet to thermal infrared.

It is a further objective that most of the scattered light from the slit can be blocked, baffled or otherwise constrained from becoming incident upon the FPA.

In accordance with the invention, there is provided a light-transfer device comprising: an optical system having an optical axis for receiving incoming light from a light source, projecting the light onto a reflecting curved surface and for focusing light returning from the curved surface onto a focal plane array (FPA); wherein the light source and the FPA are substantially symmetrical on opposite sides of the optical axis and the light projecting onto the reflecting curved surface and light returning from the reflecting curved surface each pass through the same optical elements.

In another embodiment, the optical system includes first and second refractive corrector elements operatively positioned between the light source and the curved surface for focusing incoming light onto the curved surface and focusing light returning from the curved surface onto the FPA.

In various embodiments, the first refractive corrector element is a positive power lens facing the light source and/or the second refractor corrector element is a negative power lens between the first refractive corrector element and the curved surface.

Preferably, the refractive correctors are operatively positioned closer to the light source than to the curved surface.

In one embodiment, light from the light source passing through the optical system is physically separated from light returning from the curved surface and is substantially symmetrical about the optical axis.

In preferred embodiments, light is passed to the curved surface without collimation.

In one embodiment, the curved surface is a dispersive element and in another embodiment, the curved surface is a non-dispersive mirror.

In a further embodiment, the light source to the optical system is received through a slit and may include a first optical system for focusing light on an upstream side of the slit.

In another embodiment, the light source to the optical system is received through a pinhole that may include a first optical system for focusing light on an upstream side of the pinhole.

In another embodiment, the curved surface is a diffraction grating that directs spectrally dispersed light onto the FPA.

In further embodiments, the first optical system is an optical fibre system that delivers light to the upstream side of the slit or pinhole.

In further embodiments, the FPA has an FPA axis perpendicular to the FPA and the FPA axis is tilted with respect to the optical axis.

In other embodiments, the second refractive corrector element comprises two spherical optical elements adjacent to each other on the same optical plane that may be separated from each other along the same optical axis.

In other embodiments, a field lens is optically positioned between the FPA and the first refractive corrector element.

In another embodiment, a field lens is optically positioned between the slit and the first refractive corrector element.

In another embodiment, the optical system consists of one or more doublet and one or more singlet optical elements.

In yet another embodiment, the optical system consists of three or more singlet optical elements

In further embodiments, the system may include a fold mirror or a prism having a total internal reflection optically positioned between the optical system and the FPA, such that the FPA is oriented in a plane different from the slit and/or a fold mirror or a prism with total internal reflection optically positioned between the first optical assembly and the slit.

In further embodiments, the optical system has an aspheric surface on one or more of the surfaces of the optical system.

In various embodiments, the light transfer system may have optical elements optimized for the ultraviolet (UV) wavelengths, visible and near-infrared (VNIR) wavelengths, Short Wave infrared (SWIR) spectral wavelengths, Mid-Wave infrared (MWIR) wavelengths, thermal infrared (TIR) wavelengths and/or optimized for a combination or a spectral subset of ultraviolet (UV), visible and near-infrared (VNIR), Short Wave IR (SWIR), Mid-Wave IR (MWIR) and/or thermal IR (TIR) wavelengths.

In yet another embodiment, the system may further comprise an optical multiplexing system optically connected to the light transfer system wherein light enters the optical imager through more than one slit.

### BRIEF DESCRIPTION OF THE DRAWINGS

The invention is described with reference to the drawings in which:

FIG. 1 is a typical Dyson-based spectrographic design in accordance with the prior art;

FIG. 2 is a schematic sectional view of a hyperspectral imager in accordance with one embodiment of the invention along the optical axis and in a plane parallel to the plane of the spectral dispersion;

FIG. 3 is a hyperspectral imager in accordance with one embodiment of the invention showing baffling in the form of coatings on the lenses;

FIG. 4 is a hyperspectral imager in accordance with one embodiment of the invention showing baffling in the form of physical barriers paralleling the edges of the incoming light and the diffracted light;

FIG. 5 is a hyperspectral imager in accordance with one embodiment of the invention for a compact visible near infra-red (VNIR) spectrograph with f2.8 optics;

FIG. 6 is a hyperspectral imager in accordance with one embodiment of the invention for a VNIR system with f2.8 optics and incorporating a fold mirror between the slit and the first optical element;

FIG. 7 is a hyperspectral imager in accordance with one embodiment of the invention incorporating a field lens in front of the FPA and using f2.8 to f2.5 optics;

FIG. 8 is a hyperspectral imager in accordance with one embodiment of the invention incorporating a field lens between the slit and the first optical element and using f2.8 to f2.5 optics;

FIG. 9 is a hyperspectral imager in accordance with one embodiment of the invention with one doublet and one singlet optical elements with f2.8 optics;

FIG. 10 is a hyperspectral imager in accordance with one embodiment of the invention with three singlet lenses in close proximity and with f2.8 optics;

FIG. 11 is a hyperspectral imager in accordance with one embodiment of the invention for the VNIR to short wave infra-red (SWIR) spectral range with all spherical surfaces plus extra separation between the two optical elements to improve corrections;

FIG. 12 is a hyperspectral imager in accordance with one embodiment of the invention for a spectral range of VNIR to SWIR using optics from f2.5 to f2.0 with the use of one aspheric surface;

FIG. 13 is a hyperspectral imager in accordance with one embodiment of the invention for a compact spectrograph for the SWIR spectral range with f2.0 optics and incorporating one aspheric surface;

FIG. 14 is a hyperspectral imager in accordance with one embodiment of the invention for a mid-wave infrared (MWIR) spectral range using optics of f1.5 and one aspheric surface;

FIG. 15 is a hyperspectral imager in accordance with one embodiment of the invention for the thermal infrared (TIR) spectral range with f1.5 optics;

FIG. 16 is a light transfer imager in accordance with one embodiment of the invention using a mirror rather than a diffraction grating to create a low distortion image relay in a 30 mm by 10 mm format and using f2.8 optics; and,

FIG. 17 is an embodiment of the spectrograph where the mechanical layout for an objective lens assembly and the housing for the FPA and associated electronics are included.

### DETAILED DESCRIPTION OF THE INVENTION

With reference to the Figures, improved compact, light-transfer imaging systems are described.

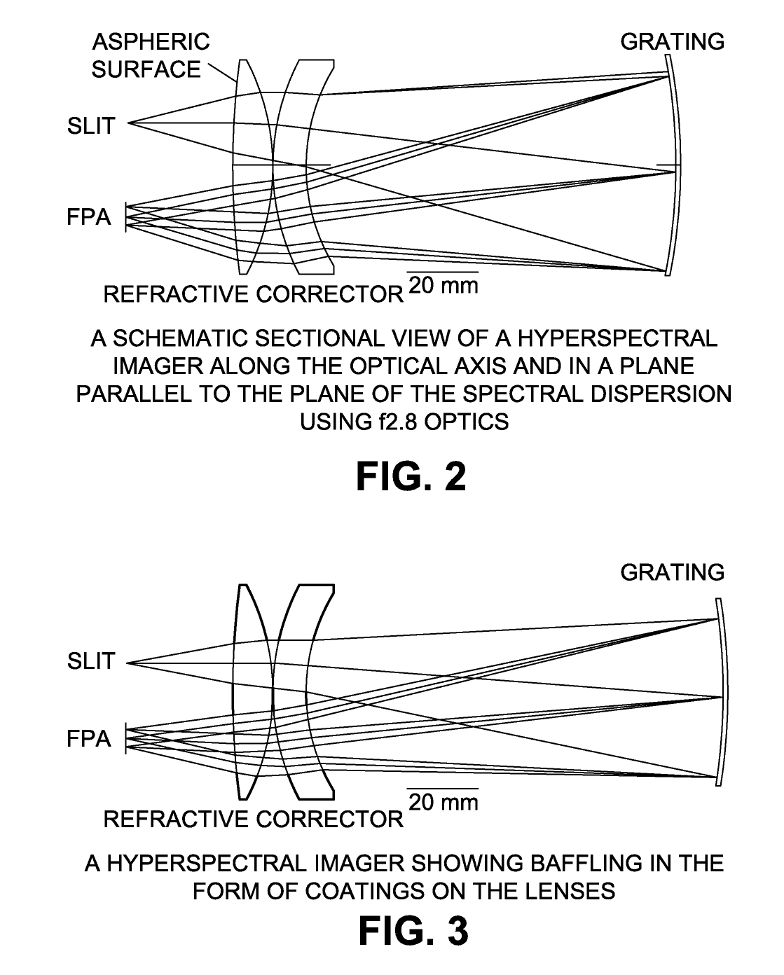

In a first type of embodiment as shown in FIGS. 2-15, the improved systems provide an optical assembly having a single optical axis for the imaging function of non-spectrally-dispersed light entering a spectrograph through a slit or pinhole onto a curved, reflecting dispersion grating with the spectrally dispersed light being subsequently focused on an FPA using the same optical assembly. This approach greatly reduces smile and keystone distortions and the designs represent a significant advantage over Offner-type designs.

In a second image relay device embodiment as shown in FIG. 16, an optical assembly is provided for the two-dimensional imaging function for light entering the relay device onto a curved reflecting mirror and for the reflected light being subsequently focused on an FPA using the same optical assembly.

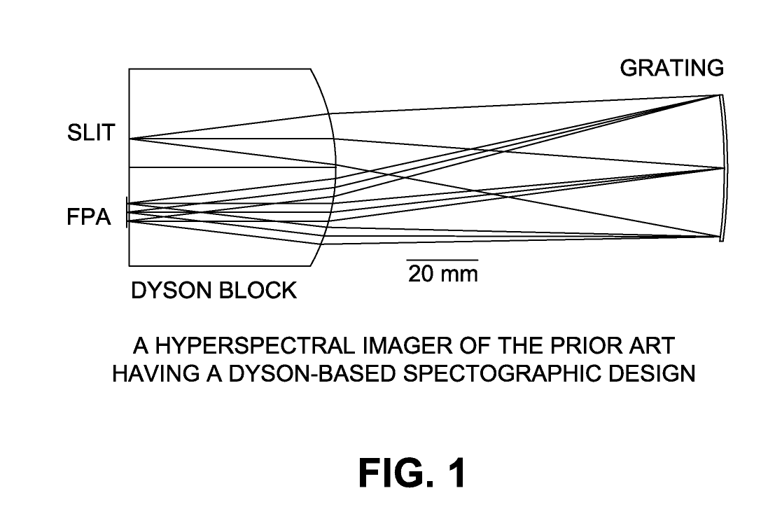

In each embodiment, the improved optical design permits a substantially increased back focal plane distance such that the FPA does not need to be immediately adjacent to the optical elements. As a result, a greater distance between the light source and the first optical element compared to past Dyson-based designs can be realized as shown in FIG. 1 and as discussed in greater detail below. These increased distances permit a greater physical separation of the light source and FPA, which is particularly advantageous for FPAs having a large number of pixels and/or large format pixels. In addition, this design also allows for improved control of stray light and also for the option of using fold mirrors or prisms in which the total internal reflection of such elements is just prior to the FPA. As a result, these designs can provide an even greater physical separation between the slit and the FPA, permitting greater flexibility in the physical layout of the spectrograph or image relay device.

Further still, the optical designs permit the use of lenses and a reflective diffraction grating or mirror that all have spherical surfaces for many wavelength ranges, which provide the advantage of being readily manufacturable, compared to aspherical surfaces required for Dyson-type optics.

An optical prescription and other optical parameters for an VNIR f2.8 hyperspectral embodiment (as shown in FIG. 1) are provided in Table 1 and Table 2 below and provide a description of a typical system as known to one skilled in the art.

TABLE 1
Example Optical Prescription

| Surface | Radius [mm] | Thickness [mm] | Material |
|---|---|---|---|
| object | infinity | 36.091 | AIR |
| 1 | 285.836 | 13.344 | S-FPL51 |
| 2 | −75.981 | 0.500 | AIR |
| 3 | 81.232 | 10.710 | F2 |
| 4 | 67.425 | 139.945 | AIR |
| stop | −203.465 | −139.945 | Diffraction grating |
| | | | with 55.5 lines/mm |
| 6 | 67.425 | −10.710 | F2 |
| 7 | 81.232 | −0.500 | AIR |
| 8 | −75.981 | −13.344 | S-FPL51 |
| 9 | 285.836 | −35.519 | AIR |
| image | infinity | 0.000 | Tilt: −178.94 deg. |

TABLE 2
Other Optical Parameters for a VNIR f2.8 Embodiment

| | | |
|---|---|---|
| Slit location | 9.892 | mm from optical axis |
| Slit length | 30 | mm |
| Spectral range | 365 to 1050 | nm |
| Slit image length | 30 | mm |
| Spectral image length | 5.76 | mm |
| Spectrometer length | 200 | mm |

| | |
|---|---|
| f/# | 2.8 |

In addition, the invention allows for a number of design options. These include inter alia:
incorporating at least one aspheric surface for spectral wavelengths in cases where the availability of suitable optical materials for lenses may be problematic;
retaining spherical surfaces for all wavelengths and adding an additional refractive corrector lens element in front of the FPA, but not in the path of the incident light coming through the slit;
retaining spherical surfaces and including a tilting of the FPA to provide superior focus at all wavelengths; and,
adopting the same basic optical design for hyperspectral line-imagers, spectrometers and image relay devices.

Further still, in accordance with the invention, the removal of the requirement to collimate the light entering through the slit substantially reduces the number of optical elements required compared to some other types of spectrographs and image relay devices, further simplifying the alignment procedures and reducing stray light.

In contrast to past designs (such as Warren), the preferred embodiment consists of one thin (compared to the thick Dyson and/or modified Dyson lens) positive power lens facing the slit/FPA and one weakly negative lens between the positive lens and grating in close proximity to the first positive lens. This use of thinner lenses means that that it is much more practical to incorporate a blocking element to minimize the scattering of incoming light compared to a Dyson-style optical design where the use of a similar type of blocking mechanism would generate much more pronounced stress patterns in the much larger Dyson lens such that the objective of achieving a homogeneous index of refraction would be much more compromised than for the optical design in this invention.

In addition, the preferred embodiment uses nearly symmetric slit/FPA displacement about the optical axis and also avoids the use of a thick initial optical component associated with the Dyson design and so permits the use of spherical lenses, including the grating which thereby minimizes athermal problems compared to having the slit aligned with the optical axis, while reducing optical aberrations.

Further still, where in a Dyson design, the refractive corrector assembly corrects only for spherical aberrations, the invention through choosing appropriate powers and materials of the lenses in the refractive corrector assembly corrects for increased lateral and axial color, coma, distortion and astigmatism.

Generalized and more specific designs are described with reference to the Figures.

FIG. 2 is a schematic sectional view of a preferred embodiment for the VNIR spectral range along the optical axis and in a plane parallel to the plane of the spectral dispersion, for the portion of a spectrograph that includes a Slit, an optical assembly (“Refractive Corrector”), and a curved diffraction “Grating” and focal plane array (“FPA”). The system may also include a first optical system that focuses light onto the slit that can be any of a number of optical designs known to those skilled in the art (including an optical fiber system) and readily determined by the use of commonly available commercial optical modeling software such as ZEMAX™.

The straight line through the two optical elements represents the common optical axis for all the optical elements. This common axis results in minimal thermal problems that can be addressed by traditional athermal design methods known to those skilled in the art.

Importantly, the subject design permits the inclusion of more effective baffling to reduce scattered light. Baffling can be placed in the spaces between or on all the optical surfaces that are not in the path of the incoming light or the spectrally dispersed light. Such effective baffling cannot be done with Dyson-type designs.

As shown in FIG. 3 an embodiment is shown in which baffling in the form of coatings on the optical elements is provided over the areas beyond those where the desired light is passing. These coatings are shown schematically as the thicker lines in FIG. 3.

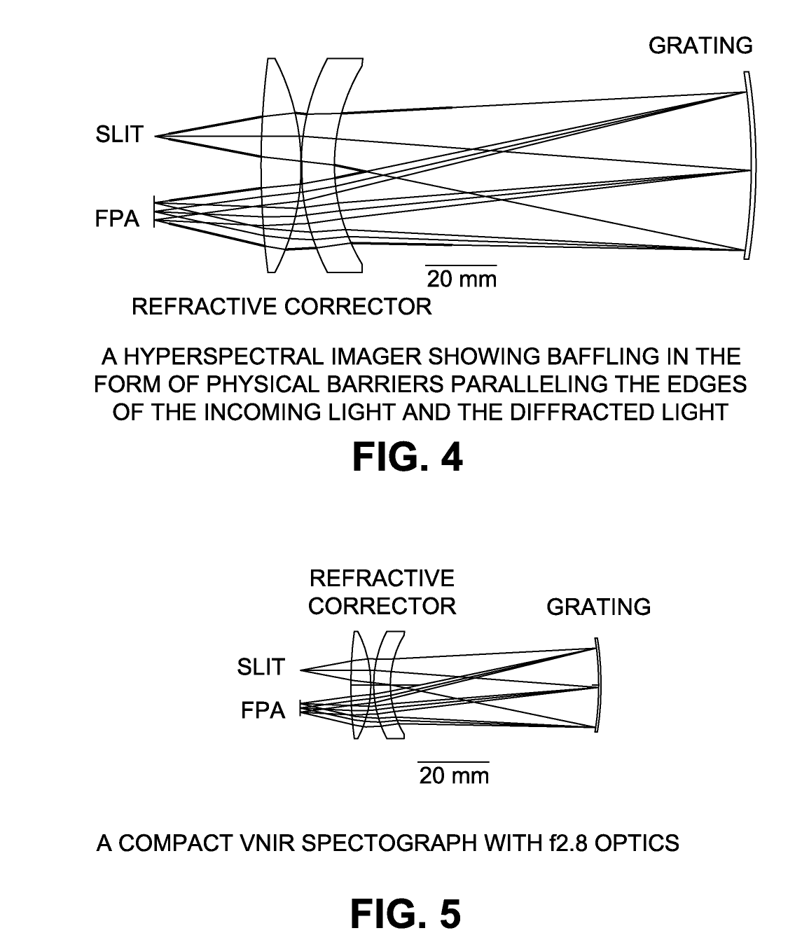

FIG. 4 shows an embodiment with an alternative baffling approach incorporating physical baffles paralleling the edges of the incoming light and diffracted light. Such baffling would preferably include a “toothed” design to minimize scattering. Other types of baffling can be readily designed and/or incorporated as known to those skilled in the art.

The orientation of the grating in the preferred embodiment is such that the zeroth order components fall in the area between the slit and the FPA, not onto the FPA itself. Baffling can be readily applied to this region to prevent any of the zeroeth order impinging on the FPA.

The FPA is also tilted slightly in the preferred embodiment to provide better aberration control. The amount of tilt can be readily determined by the use of commercial optical modeling software such as ZEMAX™.

As shown, preferred embodiments show a 30 mm focal plane and 5.8 mm dispersion. The number of spectral bands can then be calculated based upon the pixel size of the FPA. For example, if the pixel size is 20 microns, this permits 288 diffraction-limited spectral bands provided that the slit dimension is not greater than 20 microns. A larger slit width would degrade the spectral resolution and result in oversampling of the spectrum.

As noted above, FIG. 1 shows an equivalent Dyson-type spectrograph in accordance with the prior art, which for discussion and comparison with the invention, is shown at the same scale for the same type of FPA and the same 5.8 mm spectral dispersion. It is important to note that the required Dyson optical block would be substantially thicker which results in the Dyson design being substantially more difficult to manufacture with the required uniformity of refractive index especially for larger format systems. The Dyson design also has reduced capability for baffling to reduce scattered light and is considerably slower to thermalize and is more sensitive to thermal effects.

FIG. 5 shows an embodiment for a more compact design for a VNIR spectrograph with f2.8 optics with a 10 mm focal plane and 3 mm of dispersion consistent with commonly available small format FPA detectors. The advantage of the smaller size is balanced by a lower signal to noise (SNR) value or a reduced number of spectral bands. The optimal trade-offs of size, SNR and number of spectral bands is dependent on the particular application for which the sensor is designed and can be made by those skilled in the art using commercial optical design software.

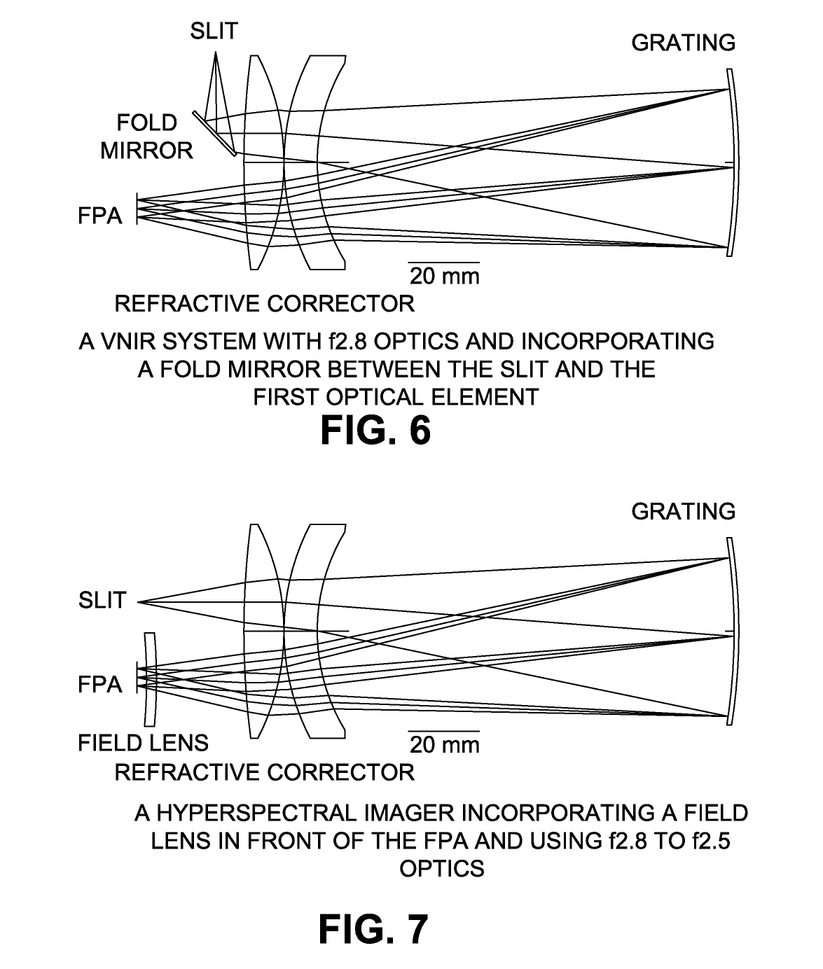

FIG. 6 shows a variation in the design of FIG. 2 in which a fold mirror is incorporated between the slit and the first optical element. This design permits a larger physical separation and a different orientation of the slit and FPA, which can have advantages for some applications where a different mechanical layout is desired.

FIG. 7 shows an embodiment as in FIG. 2 with an additional field lens placed in front of the FPA. The field lens can improve the aberration corrections and can permit slightly faster optics. Again, the optimal balance between this additional complexity of the optical system and the aberration and optical speed improvements depends upon the particular application for which the system is designed and can be readily determined using commercial optical design software.

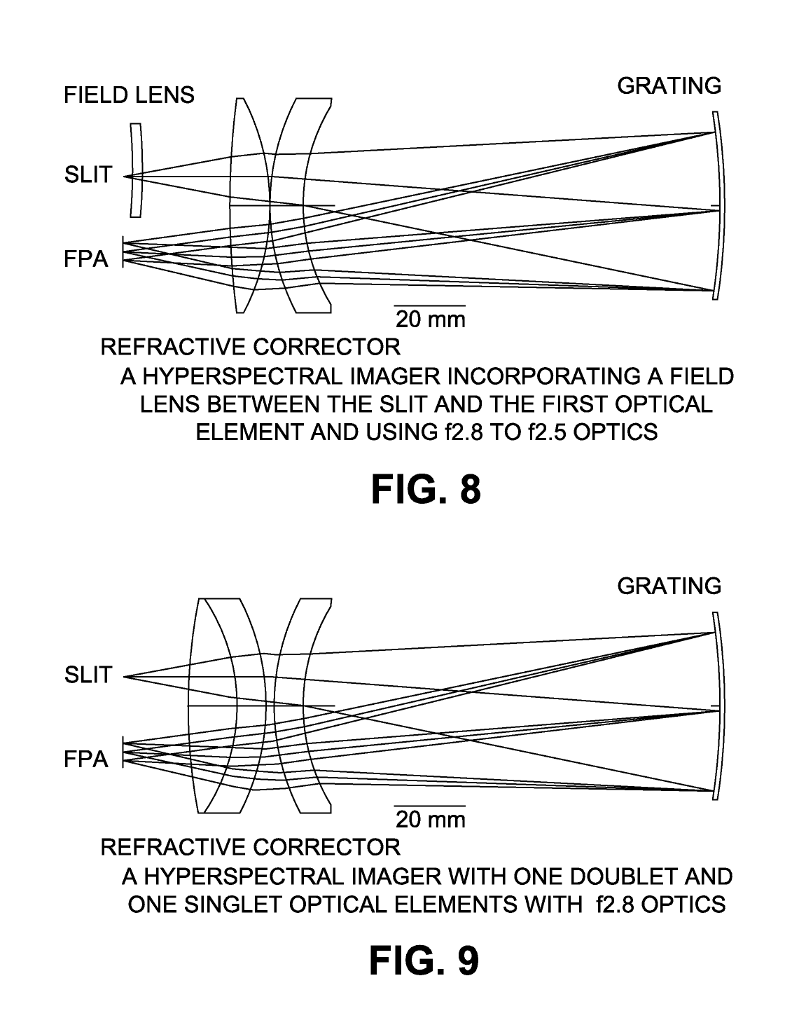

FIG. 8 shows a similar embodiment to that shown in FIG. 7 except that the field lens is placed between the slit and the first optical element.

FIG. 9 shows an embodiment with one doublet lens and one singlet lens. This embodiment has advantages when the selection of optical materials is more limited. The effect of differing optical materials can be readily assessed and simulated by those skilled in the art using commercial optical designs software. The greater separation of the two elements provides additional flexibility for the control of optical aberrations.

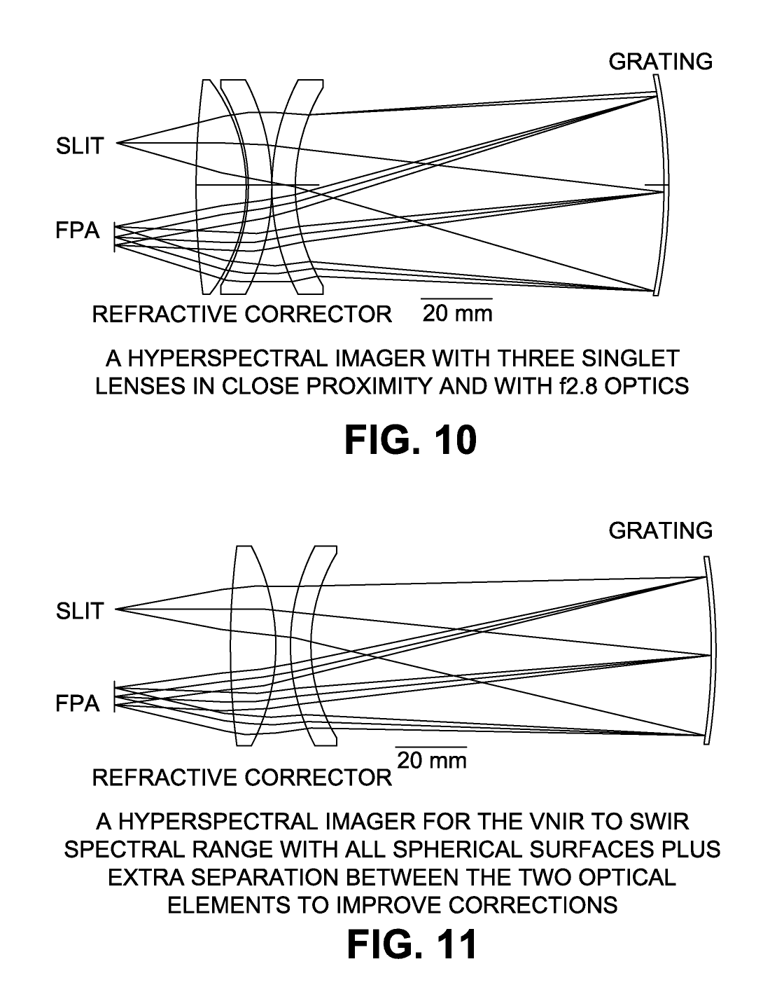

FIG. 10 shows an embodiment that incorporates three singlet optical elements in close proximity. This design has the same design characteristics as shown in FIG. 9 in terms of aberration control particularly when the choice of materials is more limited.

FIG. 11 shows an embodiment with a spectral range over the VNIR and SWIR with all spherical surfaces having f2.5 optics. The two elements are separated by a small distance (compared to the distance to the diffraction grating) to improve the aberration corrections over this wider spectral range. If the choice of optical materials is more limited, then the separation of the optical elements can be increased. The effect of differing optical materials can be readily assessed and simulated by those skilled in the art using commercial optical designs software.

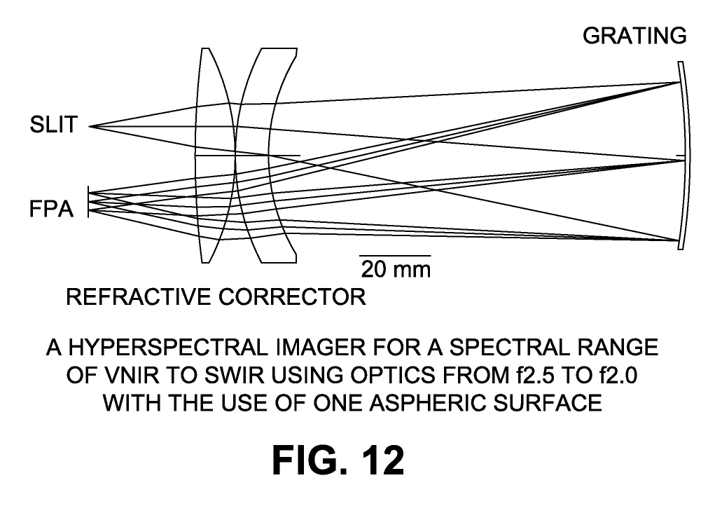

FIG. 12 shows an embodiment with a spectral range over the VNIR and SWIR, similar to the embodiment shown in FIG. 11, except that one aspheric surface is used rather than a physical separation of the optical elements. The use of the aspheric surface permits a faster optical system. The embodiment shown has f2.0 optics with diffraction limited optics at 2.5 microns.

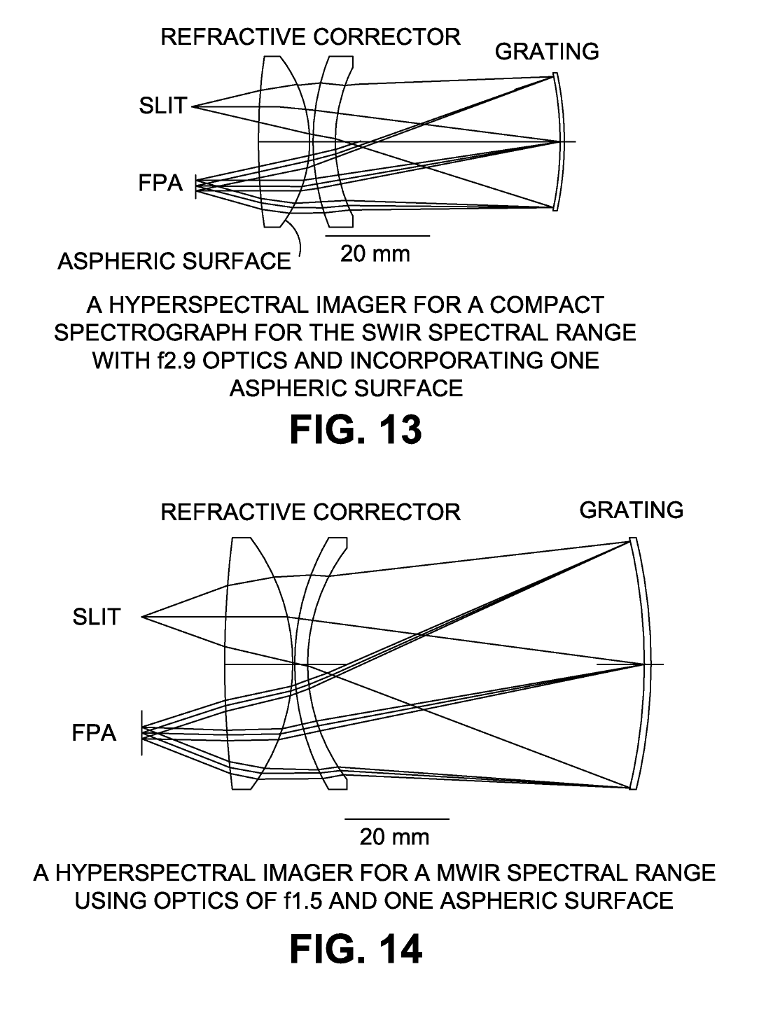

FIG. 13 shows an embodiment for a compact spectrograph for the SWIR spectral range that incorporates one aspheric surface as indicated in the Figure to enable a more compact design.

FIG. 14 shows an embodiment for the MWIR spectral range using f1.5 optics and one aspheric surface. The choice of materials normally used in the MWIR is more limited and so the preferred embodiment for the MWIR spectral range incorporates an aspheric (or one of the other aberration minimization techniques shown earlier in FIGS. 7, 8, 9 and 10).

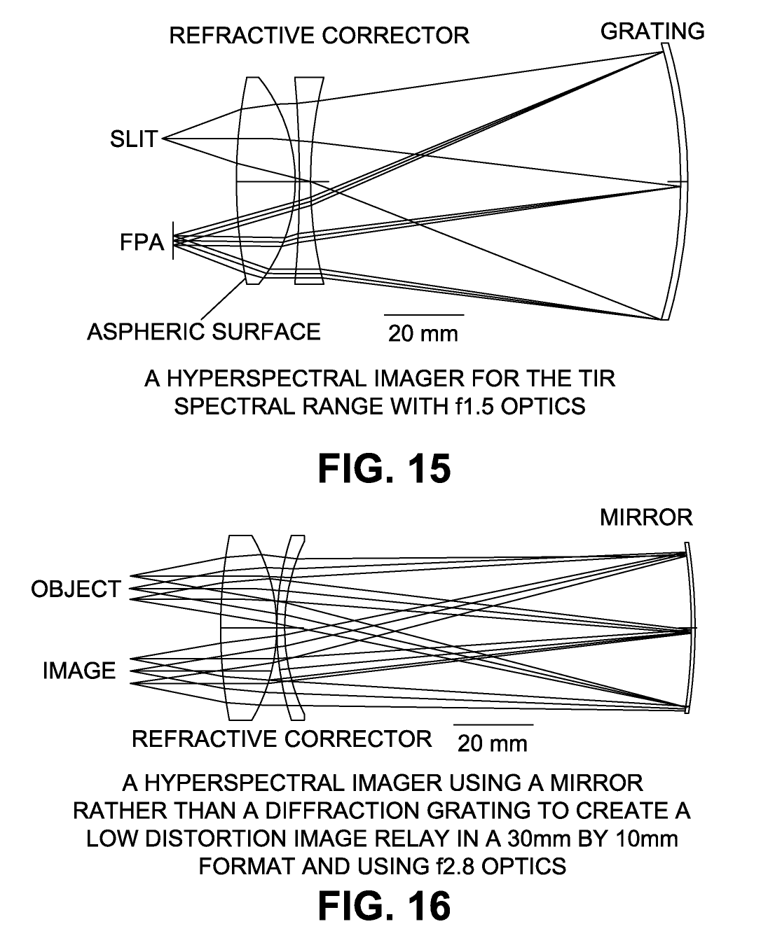

FIG. 15 shows an embodiment for the thermal infra-red (TIR) spectral range with 1.5 optics. Appropriate materials well known to those skilled in the art are available in the TIR, such that an aspheric surface is generally not required to achieve minimal aberrations.

All of the embodiments shown in FIGS. 2 through 14 will preferably include tilted FPA's as described above to reduce optical aberrations. For the TIR design shown in FIG. 15, the number of spectral bands in optical designs for the TIR spectral range is typically smaller due to SNR considerations and this smaller dispersion permits a non-tilted FPA. The non-tilted FPA design means that optical multiplexing as described in applicant's co-pending application Ser. No. 11/708,536 (now U.S. Pat. No. 7,884,931 and incorporated herein by reference) can be incorporated. The smaller dispersion typically used in the TIR spectral range enables the zeroeth order to fall on a portion of the FPA that is separated from the two first order dispersions arising from the light coming through the two slits (in a dual optically multiplexed system). This separation permits the second set of first order dispersed light coming from the second slit in the optical multiplexing design to fall onto a separate region of the FPA. The optical multiplexing design can also be used for wavelengths shorter than the TIR, if the dispersion is similarly constrained. The trade-off between the amount of dispersion and the wider swath (or other field of view orientation) enabled by optical multiplexing depends upon the particular application for which the sensor is designed.

All of the embodiments described in FIGS. 2-15 have diffraction limited optical designs. As noted, embodiments can also be designed that are not diffraction limited. While such embodiments are generally not desirable, they do have the potential for operation over a greater temperature range, since thermal effects would be masked by the lower spatial and spectral resolutions.

All of the embodiments shown have optical materials known to those skilled in the art and are generally chosen to optimize spectral transmission to provide the maximum SNR. The embodiments shown can also provide keystone and spectral smile aberrations of less than about 1 micron. It is also possible to use materials that have lower transmission but superior aberration control. The use of such materials can be advantageous if aberrations in the sub-micron range are desired for a particular application. The choice of materials used can be made by modeling the effects of different materials using ZEMAX™ or other similar software.

FIG. 16 shows an embodiment where the slit is removed and the diffraction grating is replaced by a mirror. Such an embodiment has the same advantages as the spectrographic embodiments over the Dyson design, including low distortion, compact size, flexibility in the choices in optical material, superior baffling of stray light and greater back focal length between the FPA and the optical elements. The embodiment of FIG. 16 becomes a two-dimensional image relay device similar in function to image relay devices incorporating the Dyson or Offner designs. Such relay devices are used in applications such as photo-lithography.

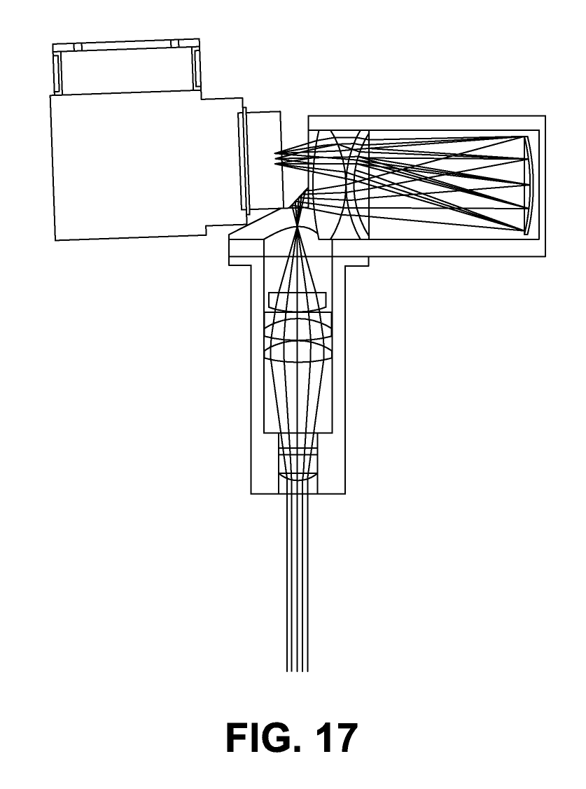

FIG. 17 shows an embodiment of the spectrograph where the mechanical layout for an objective lens assembly and the housing for the FPA and associated electronics are included. The addition of the fold mirror between the lens and the first optical component of the spectrograph provides additional flexibility in the mechanical layout for the entire sensor system.

Although the present invention has been described and illustrated with respect to preferred embodiments and preferred uses thereof, it is not to be so limited since modifications and changes can be made therein which are within the full, intended scope of the invention.

1. A light-transfer device comprising:
an optical system having an optical axis for receiving incoming light from a light source, projecting the light onto a reflecting curved surface and for focusing light returning from the reflecting curved surface onto a focal plane array (FPA);
wherein the light source and the FPA are substantially symmetrical on opposite sides of the optical axis and the light projecting onto the reflecting curved surface and light returning from the reflecting curved surface each pass through the same optical elements and the light is passed to the curved surface without collimation.

2. The light transfer system as in claim 1 wherein the optical system includes:
first and second refractive corrector elements operatively positioned between the light source and the curved surface for focusing incoming light onto the curved surface and focusing light returning from the curved surface onto the FPA.

3. The light transfer system as in claim 2 wherein the first refractive corrector element is a positive power lens facing the light source.

4. The light transfer system as in claim 3 wherein the second refractor corrector element is a negative power lens between the first refractive corrector element and the curved surface.

5. The light transfer system as in claim 2 wherein the refractive correctors are operatively positioned closer to the light source than to the curved surface.

6. The light transfer system as in claim 2 wherein light from the light source passing through the optical system is physically separated from light returning from the curved surface and is substantially symmetrical about the optical axis.

7. The light transfer system as in claim 2 wherein the optical system includes baffling on one or more lenses to reduce scattered and/or stray light.

8. The light transfer system as in claim 1 wherein the curved surface is a dispersive element.

9. The light transfer system as in claim 1 wherein the curved surface is a non-dispersive mirror.

10. The light transfer system as in claim 1 wherein the light source to the optical system is received through a slit.

11. The light transfer system as in claim 10 further comprising a first optical system for focusing light on an upstream side of the slit.

12. The light transfer system as in claim 1 wherein the light source to the optical system is received through a pinhole.

13. The light-transfer system as in claim 12 further comprising a first optical system for focusing light on an upstream side of the pinhole.

14. The light-transfer system as in claim 1 wherein the curved surface is a diffraction grating that directs spectrally dispersed light onto the FPA through the optical system.

15. The light transfer system as in claim 11 wherein the first optical system is an optical fibre system that delivers light to the upstream side of the slit.

16. The light transfer system as in claim 13 wherein the first optical system is an optical fibre system that delivers to the upstream side of the pinhole.

17. The light transfer system as in claim 1, wherein the FPA has a FPA axis perpendicular to the FPA and the FPA axis is tilted with respect to the optical axis.

18. The light transfer system as in claim 2 wherein the second refractive corrector element comprises two spherical optical elements adjacent to each other on the same optical plane.

19. The light transfer system as in claim 18 wherein the two spherical optical elements are separated from each other along the same optical axis.

20. The light transfer system of claim 2 further comprising a field lens optically positioned between the FPA and the first refractive corrector element.

21. The light transfer system of claim 10 further comprising a field lens optically positioned between the slit and the first refractive corrector element.

22. The light transfer system of claim 2 wherein the optical system consists of one or more doublet and one or more singlet optical elements.

23. The light transfer system of claim 2 wherein the optical system consists of three or more singlet optical elements

24. The light transfer system of claim 10 further comprising a fold mirror or a prism having a total internal reflection optically positioned between the optical system and the FPA, such that the FPA is oriented in a plane different from the slit.

25. The light transfer system of claim 10 further comprising a fold mirror or a prism with total internal reflection optically positioned between the first optical assembly and the slit.

26. The light transfer system of claim 2 wherein the optical system has an aspheric surface on one or more of the surfaces of the optical system.

27. The light transfer system of claim 1 having optical elements optimized for the ultraviolet (UV) wavelengths.

28. The light transfer system of claim 1 having optical elements optimized for the visible and near-infrared (VNIR) wavelengths.

29. The light transfer system of claim 1 having optical elements optimized for the Short Wave infrared (SWIR) spectral wavelengths.

30. The light transfer system of claim 1 having optical elements optimized for the Mid-Wave infrared (MWIR) wavelengths.

31. The light transfer system of claim 1 having optical elements optimized for the thermal infrared (TIR) wavelengths.

32. The light transfer system of claim 1 having optical elements optimized for a combination or a spectral subset of ultraviolet (UV), visible and near-infrared (VNIR), Short Wave IR (SWIR), Mid-Wave IR (MWIR) and/or thermal IR (TIR) wavelengths.

33. The light transfer system of claim 10 further comprising an optical multiplexing system optically connected to the light transfer system wherein light enters the optical imager through more than one slit.
